(19) United States
(12) Patent Application Publication
(10) Pub. No.: US 2015/0317482 A1
(43) Pub. Date: Nov. 5, 2015

(54) PREVENTING VISUAL OBSERVATION OF CONTENT ON A MOBILE DEVICE BY HIDING CONTENT

(71) Applicant: Mocana Corporation, San Francisco, CA (US)

(72) Inventors: James BLAISDELL, Novato, CA (US); Mike ZHANG, Fremont, CA (US)

(21) Appl. No.: 14/699,207

(22) Filed: Apr. 29, 2015

Related U.S. Application Data
(60) Provisional application No. 61/986,609, filed on Apr. 30, 2014.

(51) Int. Cl. G06F 21/60; G06F 3/0484; G06F 3/041

(52) U.S. Cl. CPC G06F 21/60; G06F 3/0416; G06F 3/04842; G06F 3/04847

(57) ABSTRACT

Users can hide content normally displayed on a mobile device screen and read or view content by touching the screen and creating a path, for example, in the shape of a circle, in which a portion of the content can be viewed. The content is hidden by a particle layer. A “hole” into the particle layer and a ghost layer is used to view content normally shown in a table view. Embodiments of the present invention allow a user to view partial content in a table (message) view, such as part of a text message, through a pre-defined area, such as a circle, square or any other shape the designer chooses while covering the other content on the screen.

### CROSS-REFERENCE TO RELATED APPLICATIONS

This application claims priority under U.S.C. §119(e) to pending U.S. Provisional Application No. 61/986,609, filed Apr. 30, 2014, entitled “GHOST MODE VIEWING OF CONTENT ON A MOBILE DEVICE,” incorporated herein by reference in its entirety.

### BACKGROUND OF THE INVENTION

1. Field of the Invention

The present invention relates to application software and computing devices. More specifically, it relates to software for hiding content on a mobile device so that it is only visible when a user touches the screen of the device.

2. Description of the Related Art

It has become increasingly important to ensure that communications are secure and kept private. Measures to make electronic and digital communications more secure have taken many forms, the most prevalent of which is to secure the transmission of voice through encryption and implementing secure tunnels (such as VPNs) to transmit the data. However, there are other ways third parties can “snoop” on communications that the sender, receiver or both intended to be secure, confidential, or even secret. One way to do this is to physically see what someone is reading on the screen of a mobile device. That is, actually see what is being typed or read on a screen. For example, a third party/intruder can literally look over the shoulder of someone who is reading a text message or email message on her phone or looking at a picture or diagram on their tablet. In some situations, there may be substantial amount of text on a screen and the reader may take some time to read all of it or may simply (and inadvertently) keep the text or content on the screen after she is finished reading it. During this time, the intruder can look over the shoulder of the intended recipient or use other means, such as binoculars, from a distance to see content on the screen. It would be desirable to be able to block or make it difficult for someone who is not the intended recipient or reader to physically read text on the screen of a mobile device.

### SUMMARY OF THE INVENTION

In one aspect of the present invention, a method of hiding content displayed on a screen is described. A user turns on a Ghost Mode feature enabling a ghost layer and a particle layer on the mobile device. The particle layer covers text displayed on the device. The ghost layer detects contact on the screen of the device when the user touches the screen. Once contact is detected, a path is created on the ghost layer. In one embodiment, it is the shape of a circle with the contact point being the center and the radius being predetermined. At the same time, content from a table view of the device showing content that would normally be shown is clipped from the table view to the path. Once the content is clipped to the path, the ghost layer on the device is re-drawn, wherein the path is shown on the ghost layer. The software then detects whether there is movement of the contact point (i.e., if the user is moving her finger on the screen). If there is movement, the ghost layer is re-drawn based on the contact point movement. The same clipping of content from the table view to the path is performed each upon each movement of the contact point. This is performed rapidly while the user is moving her finger on the screen thereby giving the illusion that the circle or path is moving and providing an aperture or hole into which the user can see the content in the table view. In one embodiment, if the system does not detect any contact with the screen, the path is closed and no circle or path is shown and the whole screen is hidden by a particle layer.

### BRIEF DESCRIPTION OF THE DRAWINGS

References are made to the accompanying drawings, which form a part of the description and in which are shown, by way of illustration, specific embodiments of the present invention:

FIG. 1 is screen diagram showing a “settings” page for a mobile device showing the feature of the present invention;

FIG. 2 is a screen diagram showing a text message screen showing messages sent by a user in accordance with one embodiment;

FIG. 3 is a screen diagram showing messages hidden so that a third-party cannot view them in accordance with one embodiment;

FIG. 4 is a screen diagram showing a circle or path in which content may be read in accordance with one embodiment;

FIG. 5 is a block diagram showing various layers of a display of a mobile device in accordance with one embodiment;

FIG. 6 is a flow diagram of a process of displaying a path in a ghost layer when software detects that a user has touched the device screen; and

FIGS. 7A and 7B are block diagrams of a computing system suitable for implementing various embodiments of the present invention.

### DETAILED DESCRIPTION OF THE INVENTION

Example embodiments of a method of hiding content normally on display on a mobile device screen, referred to as Ghost Mode or Hide Messages, and allowing the user to see that content by touching the screen and creating a path or circle into which a portion of the content can be seen is described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Methods and systems for reading and viewing content on a mobile device screen are described in the various figures. As is known in the art of UIs for mobile devices, views are presented on a display in the form of layers or views. In a conventional display, there is a table view or table layer, may also be referred to as a message view. A conventional table view may have numerous elements including text, messages, video, photos, and images (background, foreground, and the like). Embodiments of the present invention allow a user to view partial content in a table (message) view or layer, such as part of a text message, through a pre-defined area, such as a circle, square or any other shape the designer chooses while covering the other content on the screen.

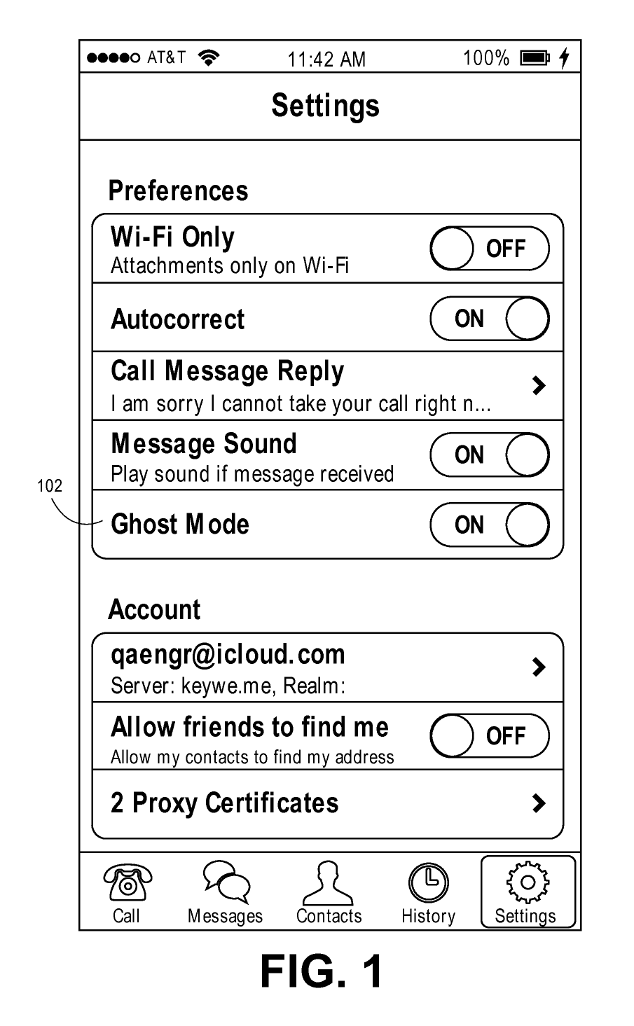

The present invention adds what may be described as “a partial content viewing” feature that can be set to ON or OFF by the user. This feature may be part of a mobile security app that makes communications, such as phone calls and text messaging, through a mobile device more secure. FIG. 1 is a screen shot of a SETTINGS page. Under PREFERENCES, the user can turn the “Hide Messages” (referred to as “Ghost Mode” by Mocana Corp. of San Francisco, Calif.) features 102 ON or OFF. In one embodiment, feature 102 (and the SETTINGS menu shown in FIG. 1) is part of a mobile security app. In FIG. 1, the user has enabled the “Hide Messages” feature.

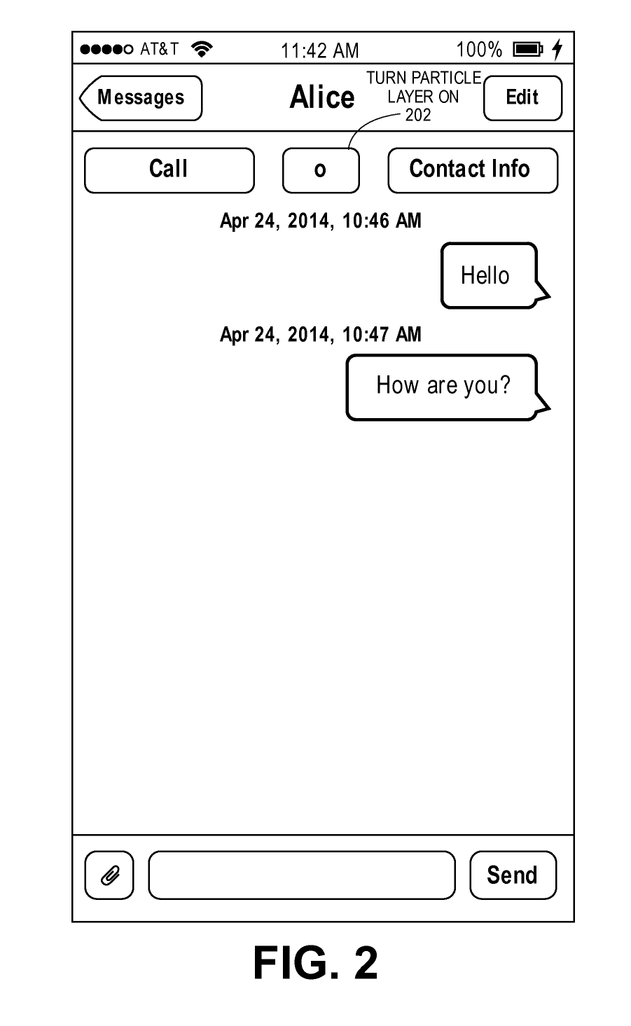

FIG. 2 is a screenshot of a text message screen showing messages sent by a user Alice. In this screen, there is an icon or button 202 which is used for hiding or revealing messages (assuming the “Hide Messages” feature or tool has been enabled). Here the button shows a small circle indicating that the messages are not hidden. In other embodiments, different types of icons or buttons may be shown or other UI methods may be used to hide or reveal messages.

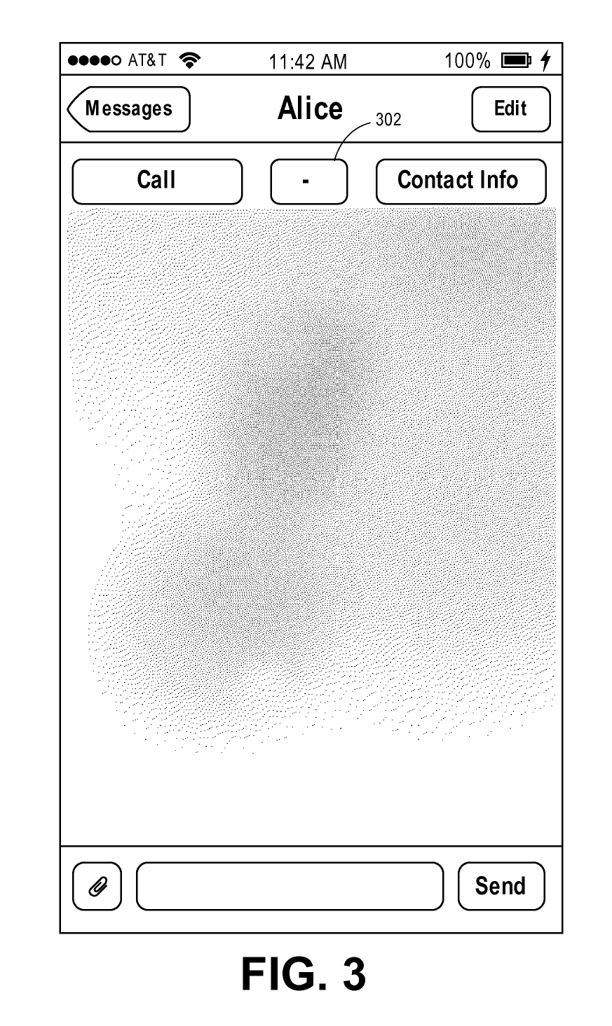

FIG. 3 is a screenshot showing messages hidden so that a third-party cannot view them. An icon 302 shows a short line indicating that the content is hidden. In one embodiment, the content is hidden “under” a layer of colored clouds or bubbles floating on the screen (not apparent in the figure because of color restrictions in patent drawings). As described below, this screen or display is the result of what may be referred to as a particle layer. It is shown without a user touching any part of the screen.

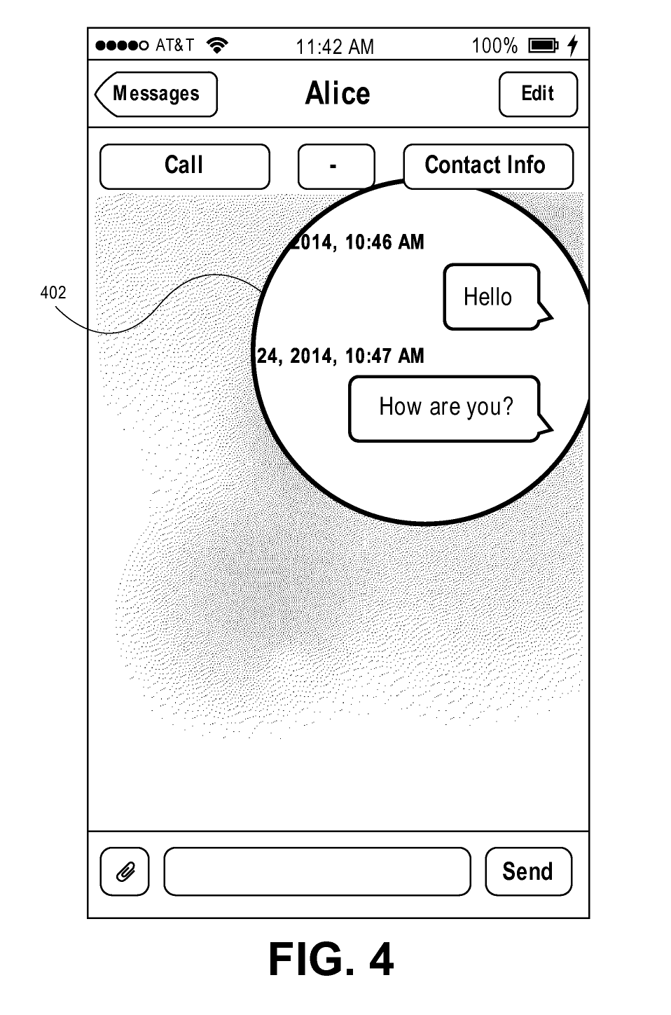

FIG. 4 is a screenshot showing a circle in which content may be read in accordance with one embodiment. A user (the intended recipient of the content) touches the screen and a circle 402 is displayed through which the underlying content can be viewed. The point of contact by the user's finger (or other object) is the center of the circle. In other embodiments, other shapes may be used. The diameter of the circle or other dimension of another shape may be pre-determined by the feature designer or developer. As described below, circle 402 and the content within the circle is another layer on top of the particle layer. The rest of the screen in FIG. 4 shows the circular bubbles floating on the screen hiding the rest of the content. The reader moves her finger around the screen to move circle 402 revealing different parts of the content and so that she can read only the text she wants to read, making it more difficult for a third party or intruder to see the other content on the screen. In other embodiments, the diameter of circle 402 can be made smaller to make it more difficult for a third-party to read the content. Once the user stops touching the screen, it returns to the screen display shown in FIG. 3. To return to the normal, un-hidden view of the text (as shown in FIG. 2), the user presses icon 302.

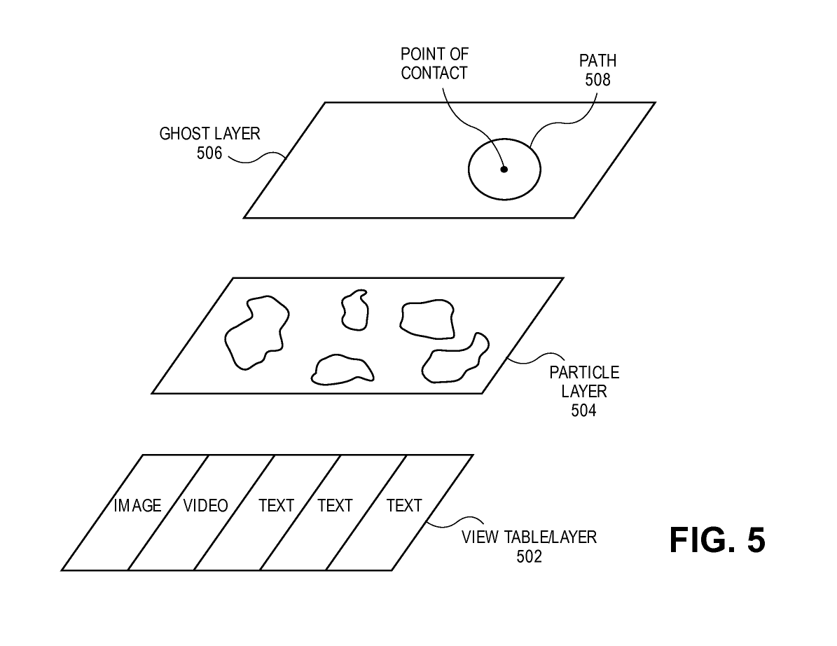

FIG. 5 is a block diagram showing various layers of a display in accordance with one embodiment. As noted above, an original table view or layer 502 is conventional in most mobile screen UIs and contains various elements normally shown on a display, such as background and foreground images, messages, e-mails, text, video, graphics and the like. These images make up the display one sees on a typical screen of their mobile device and, as such, can vary widely depending on what function the user is using.

A particle layer or table 504 is shown above conventional view table 502. This particle layer 504 is opaque and has graphic elements that hide or block the visibility of the content in view table 502, which may be, for example, text messages or e-mails. In one embodiment, as noted above, particle layer 504 has graphical elements resembling circular colored bubbles that slowly move around (float) across the screen. Of course, particle layer 504 may have any type of graphic element(s) as long as it hides or blocks the visibility of the content in table view 502.

Above particle layer 504 is another layer 506, referred to as a ghost layer. In one embodiment, ghost layer 506 is a transparent layer on top of particle layer 504. Shown in ghost layer 506 is a circular graphical element 508 which is created when a user touches the screen. As described above, when the user touches the screen, she is able to see partial text in message view 502. Ghost layer 506 may be described as activated when a user touches the screen. When the user touches the screen, a circle appears on the screen with the point of contact as the center of the circle. The visual effect seen by the user is that of the circle opening a view or aperture through particle layer 504 enabling visibility of view table 502. Through this aperture the user can see part of the content shown in view table 502. That is, it appears to the user that a portion of view table 502 is showing through circle 506.

In one embodiment this visual effect is implemented by having an image from view table 502 clipped onto circle 508. The system keeps track of the coordinates of the contact point on the screen (x,y), and the circular area around it based on a pre-determined radius from the center. The system knows the coordinate of the point of contact and the radius of the circle. It uses this data to determine what to clip from view table 502 and essentially paste to circle 508, also referred to as a path. In other words, an image is clipped from the table view to the path (i.e., circle 508) displayed in ghost layer 506. As the user moves her finger on the screen, the coordinate (x,y) constantly changes, as does the location of circle 508. However, the system only needs to keep track of coordinate (x,y). As long as the user is moving her finger the screen is constantly refreshing. Ghost layer 506 is constantly re-drawing itself by having different clips from table view 502 shown in path 508 in ghost layer 506. The re-drawing or refreshing of ghost layer 506 is done very quickly and constantly as long as the user is moving her finger on the screen. The effect of the rapid re-drawing is that visually it appears to the user that the circle is providing a view or hole through the particle layer which hides the content, the hole providing a partial view to the screen the user would normally see (table view 502). In other embodiments, particle layer 504 and ghost layer 506 may be implemented over any view within the mobile security app. In the described embodiment, these two layers, or a single layer combining these two layers, is applied to the message table view 502, but they can be applied to other views within the security app.

The important feature here is detecting whether the user is touching the screen. In one embodiment, there may be a Boolean variable keeping track of whether there is contact with the screen or not (touch variable is ON or OFF). Note that, when there is no touching on the screen, ghost layer 506 is still present, but because it is transparent and there is no circle or path 508 displayed (i.e., there is no clipping taking place), the user simply does not see ghost layer 506. In another embodiment, particle layer 504 and ghost layer 506 may be implemented as one layer, each may be described as sub-layers within a single layer.

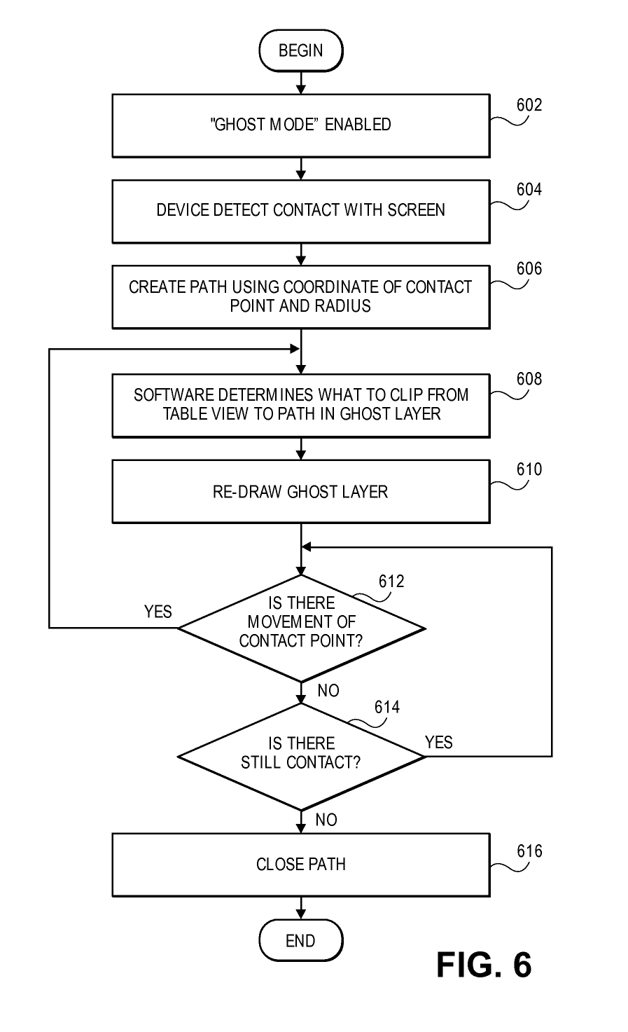

FIG. 6 is a flow diagram of a process of displaying a path in the ghost layer when the software detects that a user has touched the device screen in accordance with one embodiment. At step 602 the user enables Ghost Mode or Hide Messages mode on the device as shown in FIG. 1. This activates the particle layer and the ghost layer described above. The particle layer blocks view of the objects in the table view, that is, blocks any visual objects, text, etc. that is shown on the screen. In one embodiment, the user sees floating, lightly colored clouds covering the entire screen. At step 604 the user touches the screen and the software of the present invention detects this contact. The point of contact has a coordinate. Upon contact, a series of steps occur starting with step 606.

At step 606 a path is created using the x,y coordinate as the center of a circle having a pre-determined radius, as established by the software designer or entity implementing the present invention. Once the path is created, at step 608 the software determines what content to clip from the table view and paste into the path on top of the ghost layer. The content that would normally be shown on the screen is the content that will precisely and entirely fill the path created in step 606.

At step 610 the software re-draws the ghost layer so that the user now sees the content from the table view, but only within the path created at step 606, as shown in FIG. 4. At step 612 the software determines whether the user has moved the point of contact (i.e., has moved her finger on the screen). If there is movement, control goes back to step 608 where the software determines what to clip from the table view to the path and the ghost layer is re-drawn. This is done via rapid execution as long as the user is moving her finger on the screen, resulting in the path (circle) moving as well and table view content only being shown in the path. Although the effect of moving a finger on the screen is that the circle is moving around showing a view into the table view, actual operation is that what content to paste into the path is constantly being determined and pasted into the path. And the ghost layer is constantly being re-drawn as long as the finger (point of contact) on the screen is moving.

If at step 612 it is determined that there is no movement of the contact point, the software detects whether there is still actual contact on the screen. If there is, control goes to step 612 and the system continues to detect whether there is movement of the contact point. If there is no contact with the screen as determined at step 614, control goes to step 616 where the software closes the path created at step 606 and the table view is entirely blocked from being viewed by the user or any other observers.

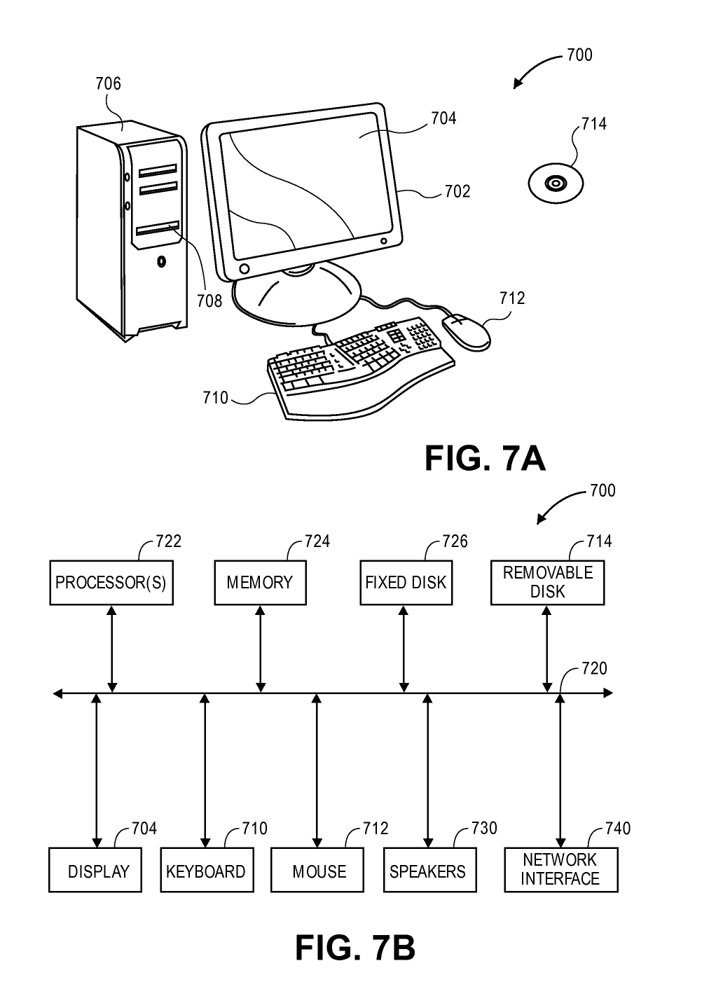

FIGS. 7A and 7B illustrate a computing system 700 suitable for implementing embodiments of the present invention. FIG. 7A shows one possible physical form of the computing system. Of course, the computing system may have many physical forms including an integrated circuit, a printed circuit board, a small handheld device (such as a mobile telephone, handset or PDA), a personal computer or a super computer. Computing system 700 includes a monitor 702, a display 704, a housing 706, a disk drive 708, a keyboard 710 and a mouse 712. Disk 714 is a computer-readable medium used to transfer data to and from computer system 700.

FIG. 7B is an example of a block diagram for computing system 700. Attached to system bus 720 are a wide variety of subsystems. Processor(s) 722 (also referred to as central processing units, or CPUs) are coupled to storage devices including memory 724. Memory 724 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 726 is also coupled bi-directionally to CPU 722; it provides additional data storage capacity and may also include any of the computer-readable media described below. Fixed disk 726 may be used to store programs, data and the like and is typically a secondary storage medium (such as a hard disk) that is slower than primary storage. It will be appreciated that the information retained within fixed disk 726, may, in appropriate cases, be incorporated in standard fashion as virtual memory in memory 724. Removable disk 714 may take the form of any of the computer-readable media described below.

CPU 722 is also coupled to a variety of input/output devices such as display 704, keyboard 710, mouse 712 and speakers 730. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 722 optionally may be coupled to another computer or telecommunications network using network interface 740. With such a network interface, it is contemplated that the CPU might receive information from the network, or might output information to the network in the course of performing the above-described method steps. Furthermore, method embodiments of the present invention may execute solely upon CPU 722 or may execute over a network such as the Internet in conjunction with a remote CPU that shares a portion of the processing.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

We claim:

1. A method of hiding content displayed on a screen, the method comprising:
enabling a ghost layer on the device;
detecting contact on the screen of the device;
creating a path using a contact point and pre-determined radius, said path on the ghost layer;
determining content to clip from a table layer to the path, wherein the table layer displays content in a conventional manner;
re-drawing the ghost layer on the device, wherein the path is shown on the ghost layer and content is shown within confines of the path;
detecting whether there is movement of the contact point; and
re-drawing the ghost layer based on contact point movement.

2. A method as recited in claim 1 further comprising:
closing the path if contact with the screen is terminated, thereby not displaying any content from the table layer.

3. A method as recited in claim 1 further comprising:
creating a particle layer, wherein the particle layer is used to visually block content in the table layer on the screen of the device; and
creating a ghost layer.

4. A method as recited in claim 1 wherein the clip from the table layer represents content from the table layer pasted into the path on the ghost layer, wherein the clip is in the shape of a circle.

5. A method as recited in claim 1 wherein detecting whether there is movement of the contact point further comprises:
determining what new content to paste from the table layer to the path based on contact point movement.

6. A method as recited in claim 1 wherein re-drawing the ghost layer based on contact point movement further comprises:
re-pasting content from the table layer to the path upon detection of contact point movement.

7. A method as recited in claim 1 further comprising:
detecting that a user has set a hide messages feature on the mobile device.

8. A method as recited in claim 3 wherein the particle layer is opaque and covers content shown in the table layer and wherein the ghost layer is transparent and shows the path only when there is contact on the screen.

9. A system for hiding messages on a screen of a mobile device using a ghost mode setting, the system comprising:
a memory storing software for implementing the ghost mode setting; and
a processor configured to:
enable a ghost layer on the device;
detect contact on the device screen;
create a path using a contact point and pre-determined radius, said path shown on the ghost layer;
determine content to clip from a table layer to the path, wherein the table layer displays content in a conventional manner;
re-draw the ghost layer on the device, wherein the path is shown on the ghost layer and content is shown within confines of the path;
detect whether there is movement of the contact point; and
re-draw the ghost layer based on contact point movement.

10. A system as recited in claim 9 wherein the processor is further configured to close the path if contact with the screen is terminated, thereby not displaying any content from the table layer.

11. A system as recited in claim 9 wherein the processor is further configured to create a particle layer, wherein the particle layer is used to visually block content in the table layer on the screen of the device and configured to create a ghost layer.

12. A system as recited in claim 9 wherein the clip from the table layer represents content from the table layer pasted into the path on the ghost layer, wherein the clip is in the shape of a circle.

13. A system as recited in claim 9 wherein the processor, configured to detect whether there is movement of the contact point, is further configured to determine what new content to paste from the table layer to the path based on contact point movement.

14. A system as recited in claim 9 wherein the processor, configured to re-draw the ghost layer based on contact point movement, is further configured to re-paste content from the table layer to the path upon detection of contact point movement.

15. A system as recited in claim 9 wherein the processor is further configured to detect that a user has set a hide messages feature on the mobile device.

16. A system as recited in claim 11 wherein the particle layer is opaque and covers content shown in the table layer and wherein the ghost layer is transparent and shows the path only when there is contact on the screen.
